(19) United States
(12) Patent Application Publication
(10) Pub. No.: US 2026/0213698 A1
(43) Pub. Date: Jul. 23, 2026

(54) APPARATUS FOR TORQUE TUBES

(71) Applicant: GRIPPLE LIMITED, Sheffield, South Yorkshire (GB)

(72) Inventor: Thomas REYNOLDS, Sheffield, South Yorkshire (GB)

(21) Appl. No.: 19/138,454

(22) PCT Filed: Dec. 12, 2023
(86) PCT No.: PCT/IB2023/062514

§ 371 Date: Jun. 12, 2025

(30) Foreign Application Priority Data
Dec. 13, 2022 (GB) 2218717.3
Dec. 5, 2023 (GB) 2318548.1

(51) Int. Cl. H02S 20/32; H02S 40/34

(52) U.S. Cl. CPC H02S 20/32; H02S 40/34

(57) ABSTRACT

A system (10) comprising a torque tube (100) and a cable diverter (300) securable to an exterior surface (101) of the torque tube (100), the cable diverter (300) comprising a base (310) securable to an exterior surface (101) of the torque tube (101), and a leg (320) to divert an elongate article (102) away from the exterior surface (101) of the torque tube (100), and wherein the elongate article (102) is cabling.

### FIELD OF THE INVENTION

Embodiments of the present invention relate to apparatus for torque tubes. Embodiments relate to a cable diverter, a system, and a method. In particular, but not exclusively, they relate to a cable diverter for a solar tracker torque tube of a solar tracker system.

### BACKGROUND TO THE INVENTION

A torque tube is a tube to transmit a torsional force from an input to an output, where the input and output are eccentrically positioned along the torque tube and thus the torque tube is designed to transmit the torsional force while resisting twisting.

Torque tubes are used in various mechanical systems, including in some solar tracker systems. A solar tracker system is a system for rotating panels to face the sun. The rotation is generally automatically controlled.

Solar panels can comprise photovoltaic panels, collector panels, reflectors, or any other appropriate solar panels.

By connecting multiple solar panels to a long torque tube, a small number of electric motors (e.g., one motor) can rotate an entire row of solar panels of a solar array.

Carriers may be provided at spacings along the span of the torque tube, to provide weight-bearing support to the torque tube. The torque tube can rotate relative to the carriers.

Cabling, such as electrical cabling, runs to the solar panels. It is advantageous to run the cabling along the torque tube because the cabling can be tied regularly to the torque tube without droop.

The cabling therefore forms part of a rotatable assembly along with the torque tube and solar panels. A static assembly includes the carriers, the motor and part of an associated drive mechanism, and a ground-engaging structure such as a column.

During rotation of the rotatable assembly, the cabling along the torque tube will slide against parts of the static assembly such as the carriers and/or parts of the drive mechanism.

### BRIEF DESCRIPTION OF VARIOUS EMBODIMENTS OF THE INVENTION

According to an aspect of the invention there is provided an apparatus comprising a base securable to an exterior surface of a torque tube, and a leg extending away from the base to divert an elongate article away from the exterior surface of the torque tube.

According to an aspect of the invention there is provided a system comprising a torque tube and an apparatus securable to an exterior surface of the torque tube, the apparatus comprising a leg to divert an elongate article away from the exterior surface of the torque tube. The apparatus may optionally comprise the base.

According to an aspect of the invention there is provided a method comprising: securing a apparatus, having a leg, to an exterior surface of a torque tube so that the leg of the apparatus extends away from the exterior surface of the torque tube, to divert an elongate article away from the exterior surface of the torque tube. The apparatus may optionally comprise the base.

According to an aspect of the invention there is provided a system comprising the apparatus and a malleable strap to secure the apparatus to the torque tube.

According to an aspect of the invention there is provided a malleable strap.

Optionally, the elongate article is cabling such as electrical cabling. Therefore, optionally, the apparatus is a cable diverter.

An advantage of the cable diverter is that the cabling can be protected from collision with an obstruction such as a carrier for the torque tube. This is because the leg bridges the cabling over the static part. Therefore, damage and abrasion is avoided. An advantage of securing the cable diverter to the torque tube, rather than to a static part, is that the cable diverter is attached to the same moving part as the cabling, and therefore there is no relative movement between the cabling and the cable diverter.

According to an aspect of the invention there is provided a diverter comprising a base securable to an exterior surface of an article, a leg extending away from the base, and a beam elevated from the base by the leg, and configured to secure cabling. In some examples, the article is part of a solar tracker system. In some, but not necessarily all examples, the exterior surface of the article is a face of a torque tube.

The following dependent features are applicable to any one or more of the preceding aspects.

The torque tube may be a solar tracker torque tube of a solar tracker system. The system referred to above may be the solar tracker system. The method may be a method of assembling the solar tracker system.

A total elevated span of the cable diverter may be in the order of magnitude of tens of centimetres. An advantage is that the span is sufficient to bridge over a plurality of adjacent bearing assemblies, while remaining rigid, while having minimal material usage, and while having a compact base.

The cable diverter may be secured to, securable to, or configured to be secured to the exterior surface of the torque tube such that the leg comprises an oblique angle to the exterior surface of the torque tube.

An advantage is minimising cabling stresses. This is to allow the cabling following the leg to have a higher bend radius.

The leg of the cable diverter may comprise an oblique angle to the base of the cable diverter.

The value of the oblique angle may be approximately 10 or more degrees off-perpendicular.

The value of the oblique angle may be no more than approximately 30 degrees off-perpendicular. An advantage is that the cable diverter is compact in length, minimising material use and minimising span length to reduce stress and deflection.

An internal angle between the base and the at least part of the length of the leg may be an obtuse angle. This defines the oblique angle. An advantage is enabling the internal angle to be formed by a bending operation with minimal fatigue at the bend. Another advantage is that the base can be located further away from the obstruction than if the internal angle was perpendicular or even acute.

A height of the leg may be a value from the range approximately five centimetres to approximately 30 centimetres.

This height range advantageously enables the cabling to pass between the obstruction and a rear face of a solar panel, without contacting either of them. An advantage of the minimum height is compatibility with a wide range of obstruction sizes from manufacturers. Another advantage of the minimum height is that if the cable diverter is a half-bridge design (as will be discussed), there is more freedom over how far upstream of the obstruction the cable diverter can be positioned along the torque tube. The terms ‘upstream’ and ‘downstream’ are defined based on the direction faced by the cable diverter.

The leg may comprise a plate section. The leg may be a section of a same plate as the base.

The leg may be connected to the base via an edge (lower edge). The edge may comprise a bend (forward/along-span bend). An advantage bending an article into distinct sections is ease of manufacture.

The leg may be configured to secure the cabling. For example, the leg may comprise a fastening point (leg fastening point) to receive a cable fastener. The cable fastener may comprise a cable tie. The fastening point may comprise a throat such as a through-hole or edge slot. The leg may comprise a pair of the fastening points, to receive the cable fastener in a cross-span direction. The leg may comprise a pair of said pairs of fastening points, each pair separated from the other along a span length of the leg.

The leg may be configured to secure the cabling. For example, the leg may be shaped as a cable tray. The leg may comprise a floor (leg floor) and a support rail (leg support rail). The leg may comprise the floor and a pair of the support rails. The support rails may be left and right support rails, the floor extending therebetween. The floor and the support rails may be arranged to define the cable tray. The support rails and floor may extend along the leg.

The support rail(s) may be at an oblique angle to the floor. An internal angle between the floor and the support rail may be an obtuse angle. An advantage is enabling stacking and nesting of multiple ones of the cable diverter.

If the leg comprises a plate section, the support rails and floor may be portions of the plate section. The support rails may be connected to the floor by respective lateral bends. An advantage is improved rigidity because the support rails act as strengthening ribs. A further advantage is ease of manufacture.

If the leg additionally comprises the fastening point, a support rail may comprise at least part of the fastening point. If the leg comprises at least one pair of the fastening points, each support rail may comprise a respective one of the fastening points of the pair. Each said support rail may extend away from the floor at the oblique angle. Therefore, an advantage is that the fastening points are spaced far apart, close to the lateral extremities of the leg, to accommodate a wide bundle of cables.

The fastening point may extend through one of the respective lateral bends and into the floor. If the leg comprises at least one pair of the fastening points, each fastening point of the pair may extend through a respective one of the respective lateral bends and into the floor. An advantage is that the fastening points are wide to accommodate

The cable diverter may comprise a beam (elevated beam). The beam may be elevated from the base by the leg. The beam may be configured to secure the cabling.

The beam may be angled to extend along the torque tube in a direction more parallel to the torque tube/base than at least part of the leg. The direction may be approximately parallel or within five degrees thereof. An internal angle between the leg and the beam may be an obtuse angle.

The beam may comprise a plate section. The beam may be a section of a same plate as the leg.

An advantage of the beam is that the cabling can be further guided over the obstruction by the beam. The cabling may be securable to the beam.

The beam may be connected to the leg. The beam may be connected to the leg via an edge (upper edge). The edge may comprise a bend (forward/along-span bend). An advantage is ease of manufacture.

The beam has a length from the edge (upper edge). The length of the beam may be in the order of magnitude of tens of centimetres.

The beam may be configured to secure the cabling. For example, the beam may comprise a fastening point (beam fastening point) to receive a cable fastener. The cable fastener may comprise a cable tie. The fastening point may comprise a throat such as a through-hole or edge slot. The beam may comprise a pair of the fastening points, to receive the cable fastener in a cross-span direction. The beam may comprise a pair of said pairs of fastening points, each pair separated from the other along a span length of the beam.

The beam may be configured to secure the cabling. For example, the beam may be shaped as a cable tray. The beam may comprise a floor (beam floor) and a support rail (beam support rail). The beam may comprise the floor and a pair of the support rails. The support rails may be left and right support rails, the floor extending therebetween. The floor and the support rails may be arranged to define the cable tray. The support rails and floor may extend along the beam.

The support rail(s) of the beam may be at an oblique angle to the floor of the beam. An internal angle between the floor and the support rail may be an obtuse angle. An advantage is enabling stacking and nesting of multiple ones of the cable diverter.

If the beam comprises a plate section, the support rails and floor may be portions of the plate section. The support rails may be connected to the floor by respective bends (lateral/cross-span bends). An advantage is improved rigidity because the support rails act as strengthening ribs. A further advantage is ease of manufacture.

If the leg also comprises support rails, the support rails of the leg may be separated from the support rails of the beam by discontinuities. The discontinuities may be aligned with the edge (upper edge) between the leg and the beam.

If the beam additionally comprises the fastening point, a support rail of the beam may comprise at least part of the fastening point. If the leg comprises at least one pair of the fastening points, each support rail may comprise a respective one of the fastening points of the pair.

The fastening point may extend through one of the respective lateral bends of the beam and into the floor of the beam. If the beam comprises at least one pair of the fastening points, each fastening point of the pair may extend through a respective one of the respective lateral bends and into the floor.

The beam may be a cantilever beam, cantilevered from the leg. An advantage of this ‘half-bridge’ implementation is minimal material usage to achieve the required effect. A further advantage is compatibility, in case there is nowhere convenient to attach a second leg.

The beam may comprise a turned-down free end. An advantage is guiding the cabling and avoiding contact with a sharp edge. An angle of the turned-down free end may be obtuse, such as 10-45 degrees. An advantage is that the angle is steep enough to prevent cable abrasion, and shallow enough to enable stacking and nesting of multiple ones of the cable diverter.

Alternatively, the beam may be connected to both the leg and to a second leg. The legs may be angled towards each other. Opposite ends of the beam may be connected to the respective legs. An advantage of this ‘full-bridge’ implementation is increased rigidity and support.

The base may comprise a plate section. The base may be a section of a same plate as the leg.

The base may be shaped to fit the torque tube. An advantage is that the connection to the torque tube is more rigid. The base may be shaped to extend around a portion of a perimeter of the torque tube. The base may be shaped to fit the torque tube if the torque tube is polygonal or at least comprises a flat side. The base may be shaped to extend over a first face of the torque tube and at least part way over at least a pair of adjacent faces of the torque tube.

The base may comprise lateral protrusions and a floor therebetween. The lateral protrusions may extend below a level of the floor of the base, to extend at least partially around the torque tube. The lateral protrusions and floor may be portions of the plate section. The lateral protrusions may be connected to the floor by respective downwards bends (lateral/cross-span bends). By contrast, one or more of the earlier-described bends may be upwards bends.

The lateral protrusions may be at an oblique angle to the floor of the base. An internal angle between the floor and the support rail may be an obtuse angle. An advantage is enabling stacking and nesting of multiple ones of the cable diverter.

If the leg also comprises support rails, the lateral protrusions of the base may be separated from the support rails of the leg by discontinuities. The discontinuities may be aligned with the edge (lower edge) between the base and the leg.

The torque tube may be polygonal or approximately circular in cross-section. Being a polygon advantageously resists slippage of bracketry enveloping the torque tube. If polygonal, the torque tube may have four or more sides. In some examples, the torque tube has at least six sides or at least eight sides. Having more sides, or being circular, may reduce shear stress.

The base may be connectable to the torque tube by a malleable strap. The system may comprise the malleable strap. The malleable strap may be wrappable/wrapped around the torque tube. The malleable strap may be wrappable/wrapped around the base of the torque tube.

An advantage of the malleable strap is that the cable diverter can be securely held without a need to drill holes into the torque tube, or weld anything to the torque tube. It would be appreciated that holes could be drilled into the torque tube in addition to, or instead of, using a malleable strap. Other solutions include adhesives.

The malleable strap may comprise a plate.

If the torque tube is polygonal in cross-section, the malleable strap may comprise living hinges, a location of each living hinge corresponding to the location of a corresponding vertex of the torque tube. An advantage is that the malleable strap is easier to bend around the torque tube. Further, the living hinges may be sized to enable hand-bending of the malleable strap.

The malleable strap may comprise a first series of living hinges defining a first folding pattern for a first polygon having a first number of sides, and may comprise a second series of living hinges defining a second folding pattern for a second polygon having a second number of sides. An advantage is that the malleable strap is universal to a plurality of polygonal torque tube shapes.

The discontinuities between the lateral protrusions of the base and the support rails of the leg may be sized to receive the malleable strap. The lateral protrusions and the leg may together prevent the base from sliding out of the malleable strap when the

The malleable strap may comprise a wrapping portion and an attachment portion at each end of the wrapping portion. When the malleable strap has been wrapped around the torque tube, the attachment portions may align, enabling the attachment portions to be fastened together, for example by a fastener. The malleable strap is then in a fastened state.

The attachment portions and wrapping portion may be portions of a same plate. The attachment portions may be connected to a wrapping portion of the plate by respective bends and/or living hinges.

The malleable strap may be received in a flattened state. The method may comprise folding the living hinges to secure the cable diverter to the torque tube.

The malleable strap may be configured as a ductile strap. The malleable strap may comprise a metal material. An advantage is that the strap is stronger and more durable than a plastic cable tie, while still being pliable. The cable diverter may comprise a metal material. An advantage is that the cable diverter is sufficiently rigid to provide a solid/rigid base for the cabling.

An exposed surface of the cable diverter may be electrically conductive. For example, at least part of the cable diverter may comprise the metal material, and the metal material may be exposed at an exterior surface of the cable diverter. The base, leg, and beam may be electrically conductively coupled. The base may be electrically conductively coupled to the torque tube. An advantage is that the cable diverter is suited for bonding/earthing. For example, the cabling may be for transmitting several kilowatts of electrical power.

The cable diverter may comprise or consist of a plate comprising a plurality of the forward and lateral bends as described above.

The torque tube may comprise a metal material. The torque tube may be hollow.

The torque tube may be a solar tracker torque tube of a solar tracker system.

The solar tracker system may be a single-axis solar tracker system, configured to rotate solar panels about a solar panel axis parallel to, or coaxial with, a torque tube axis about which the torque tube is rotatable.

The torque tube may have a span length in the order of magnitude of metres or in the order of magnitude of tens of metres. The span length of the torque tube may be suitable for supporting a row of solar panels.

The torque tube may further comprise a drive input to receive torque from an electric motor. The drive input may comprise a rotor. The drive input may form part of a drive mechanism connecting the electric motor to the torque tube. The drive input may be toothed for meshing engagement with another part of the drive mechanism.

The solar tracker system may further comprise the carrier of the torque tube. The carrier may be a bearing assembly. The carrier may comprise a drive input bearing assembly, proximal to the drive input, or a span support bearing assembly distal from the drive input.

The cable diverter may be secured at a position along the torque tube dependent on a position of the carrier of the torque tube. The positioning of the cable diverter may be to prevent the cabling from contacting the carrier.

The cabling may be electrical cabling. The cabling may be solar panel cabling. The cabling may be a bundle comprising a plurality of cables. The solar tracker system may further comprise the cabling.

According to a further aspect of the invention, there is provided a system comprising the cable diverter and the malleable strap.

### BRIEF DESCRIPTION OF THE DRAWINGS

For a better understanding of various examples of embodiments of the present invention reference will now be made by way of example only to the accompanying drawings in which:

FIG. 1 illustrates a perspective view of an example system;

FIG. 2 illustrates a rear elevation of an example solar tracker system;

FIG. 3 illustrates a section A-A from FIG. 2;

FIG. 4 illustrates a section B-B from FIG. 2;

FIG. 5 illustrates a top view of an example half-bridge cable diverter secured to a torque tube;

FIG. 6 illustrates a top view of an example full-bridge cable diverter secured to a torque tube;

FIG. 7 illustrates a front perspective view of an example half-bridge cable diverter;

FIG. 8 illustrates a side view of the half-bridge cable diverter of FIG. 7; and

FIG. 9 illustrates a perspective view and detail view of an example malleable strap.

### DETAILED DESCRIPTION OF VARIOUS EMBODIMENTS OF THE INVENTION

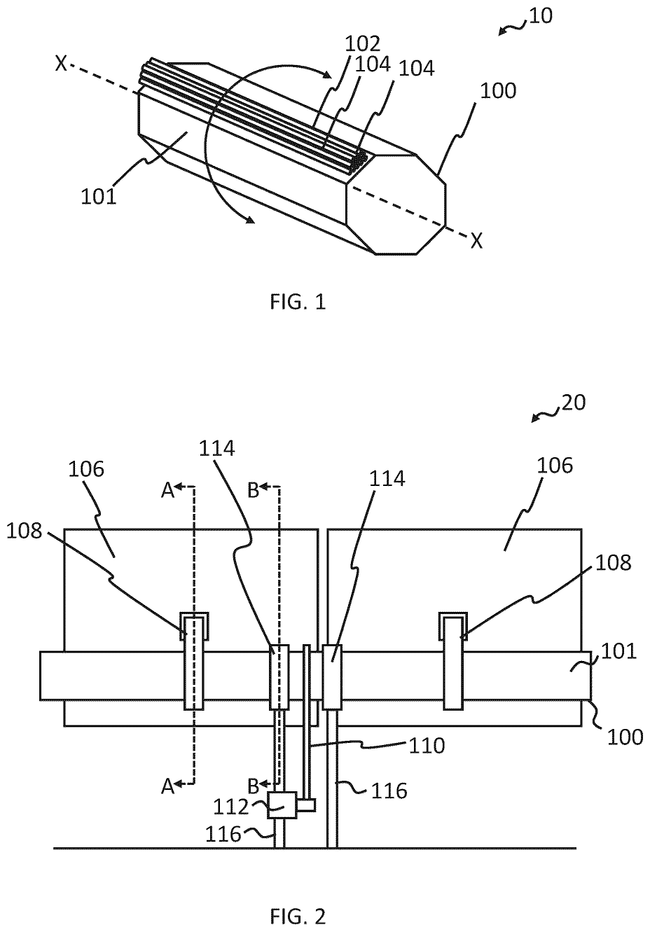

FIG. 1 illustrates a perspective view of a system 10 comprising an example solar tracker torque tube 100 (‘torque tube’ herein), and cabling 102 running along the torque tube 100. The term ‘cabling’ is defined herein as one or more cables 104, such as a bundle of cables 104 as shown. The term ‘torque tube’ is as-defined in the background section.

The illustrated torque tube 100 has an octagonal cross-section. It would be appreciated that the torque tube 100 could have a different polygonal or circular cross-section shape than that shown.

The torque tube 100 can be of hollow extruded metal form, without limitation.

The torque tube 100 has a longitudinal tube axis X-X. The torque is rotatable about the axis X-X.

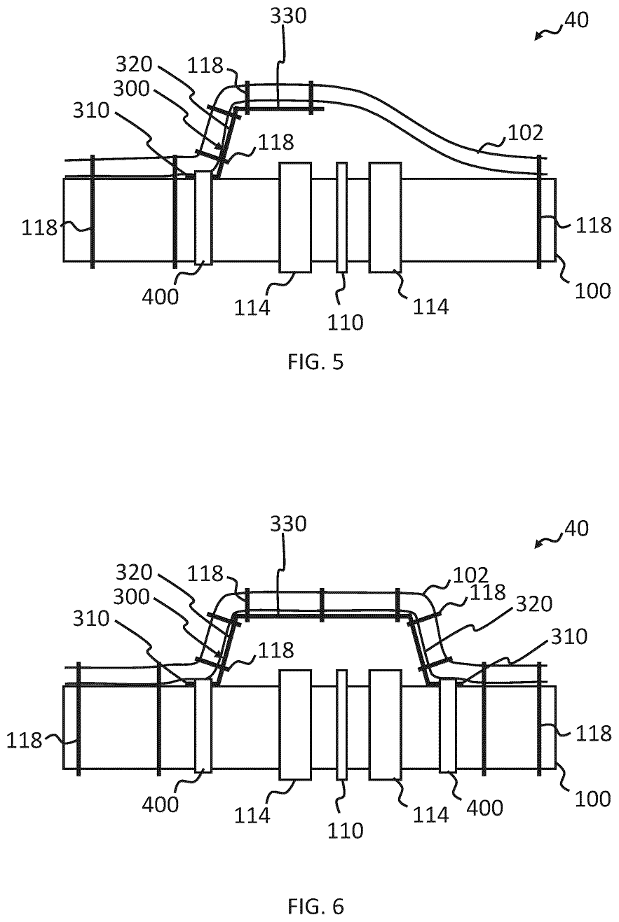

The cabling 102 is secured to the exterior surface 101 of the torque tube 100 via any appropriate cable fasteners 118 (see FIGS. 5-6) such as plastic cable ties. Therefore, rotation of the torque tube 100 about the axis X-X also rotates the cabling 102 about the axis X-X.

In an implementation, the cabling 102 is electrical solar panel cabling, electrically connecting one or more solar panels 106 to power electronics (not shown). The cabling 102 may carry generated solar energy and/or communication signals. As described earlier, it is desirable to prevent contact between the cabling 102 and static non-rotatable bodies, to prevent the cabling 102 from catching on anything or suffering frictional insulation damage.

FIGS. 2-4 illustrate a rear elevation view, and side sectional views, of a solar tracker system 20 comprising the system 10 of FIG. 1 and additional components.

The solar tracker system 20 FIG. 2 comprises the torque tube 100, bracketry 108 for connecting solar panels 106 to the torque tube 100, an electric motor 112 to rotate the torque tube 100, ground-engaging structures 116, and carriers in the form of bearing assemblies 114 to support the torque tube 100. The solar panels 106 may or may not form part of the supplied solar tracker system 20, depending on supply chains.

A single electric motor 112 can rotate the plurality of solar panels 106 via the torque tube 100. A single electric motor 112 may rotate an entire row of solar panels 106 via the torque tube 100.

The illustrated solar tracker system 20 is a single-axis solar tracker system, configured to rotate solar panels 106 about a solar panel axis which is at least parallel to the axis X-X, and optionally the same as the axis X-X. A single-axis solar tracker system has only one degree of rotational freedom.

In situ, the axis X-X of the solar tracker system 20 may be orientated to enable the highest possible solar power captured over a day, while meeting any other site constraints. The manner in which the rotation is automatically controlled to track the sun is outside the scope of this disclosure.

Modifications could be made to convert the solar tracker system 20 to a multi-axis solar tracker system. Such modifications are outside the scope of this disclosure.

The torque tube 100 has a span length suitable for supporting a row of solar panels 106 of a solar array. The length is likely in the order of magnitude of tens of metres. FIG. 2 shows only two solar panels 106, for illustrative purposes. In practice, a row may comprise ten or more solar panels 106 depending on available space.

FIG. 2 illustrates a plurality of the bearing assemblies 114. Each bearing assembly 114 comprises a bearing through which the torque tube 100 extends, a bearing housing, and a support such as a column, the support defining at least part of a ground-engaging structure 116.

The number of bearing assemblies 114 and their centre-to-centre spacings depends on factors such as the stiffness of the torque tube 100, the span length of the torque tube 100 (row length), the weight of the solar panels 106, site conditions, etc. A short torque tube may only be supported by two bearing assemblies 114. A long torque tube may be supported by additional bearing assemblies 114.

Due to the stiffness of the torque tube 100, the number of bearing assemblies 114 required may be fewer than the number of solar panels 106 supported by the torque tube 100. Likewise, the number of ground-engaging structures 116 may be fewer than the number of solar panels 106.

As shown in FIG. 2, the torque tube 100 comprises a single drive input 110 in the form of a rotor. The rotor forms part of a drive mechanism to transmit torque from the electric motor 112 to the torque tube 100. The rotor may be fixed to the torque tube 100 and may comprise gear teeth, sprocket teeth, or any other appropriate coupling means. Alternatively, the drive input 110 may comprise another form of drive input such as a belt pulley.

FIG. 2 shows the electric motor 112 coupled to the drive input 110. The coupling can be direct or indirect. Any appropriate drive input and drive mechanism may be used.

In FIG. 2, the drive input 110 is located centrally within the row, such as within a central third/central fifth of the row. This ensures a symmetrical distribution of load.

In FIG. 2, a pair of drive input bearing assemblies 114 is provided, proximal to the drive input 110. Further, distal bearing assemblies are not shown but could be provided if the row is longer.

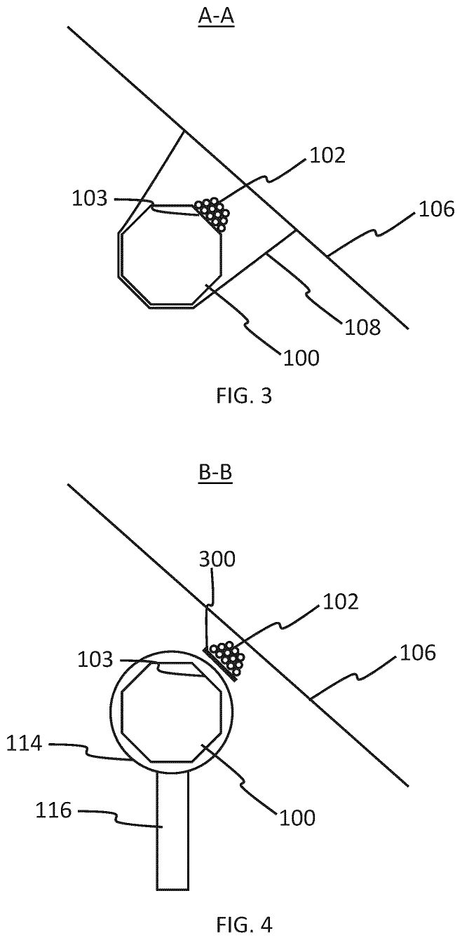

FIG. 3 illustrates a side view section A-A from FIG. 2, looking along the row (along the axis X-X). The section A-A is through example bracketry connecting a solar panel 106 to the torque tube 100.

The bracketry 108 in FIG. 3 is in the form of a strap, attached at one end to a rear of the solar panel 106, wrapped around the torque tube 100, and attached at the opposite end of the strap to the rear of the solar panel 106. The polygonal shape of the torque tube 100 resists slippage of the strap. The form and materials of the bracketry 108 may further resist slippage. It would be appreciated that different bracketry could be provided, and that the bracketry 108 depends on the shape of the torque tube 100.

To prevent the cabling 102 from contacting the bracketry 108, the cabling 102 extends along the space in between the torque tube 100 and the rear of the solar panel 106. The strap wraps around a subset of faces/sides of the torque tube 100, not including the face/side 103 of the torque tube 100 along which the cabling 102 extends.

FIG. 4 illustrates a side view section B-B from FIG. 2, further along the torque tube 100 than the section A-A. The section B-B is through a bearing assembly 114 supporting the torque tube 100. As shown, the bearing assembly 114 is disposed in the path of the cabling 102 of FIG. 3.

To prevent the cabling 102 from contacting the bearing assembly 114, and rubbing against it during rotation, a cable diverter 300 is provided in accordance with one or more aspects of the invention.

FIG. 4 shows a cross-section through a portion of the cable diverter 300 that is elevated above the exterior surface 101 of the torque tube 100. The elevated portion of the cable diverter 300 acts as a bridge along which the cabling 102 runs, and to which the cabling 102 may be securable.

The cable diverter 300 is now described in more detail with reference to FIGS. 5-8.

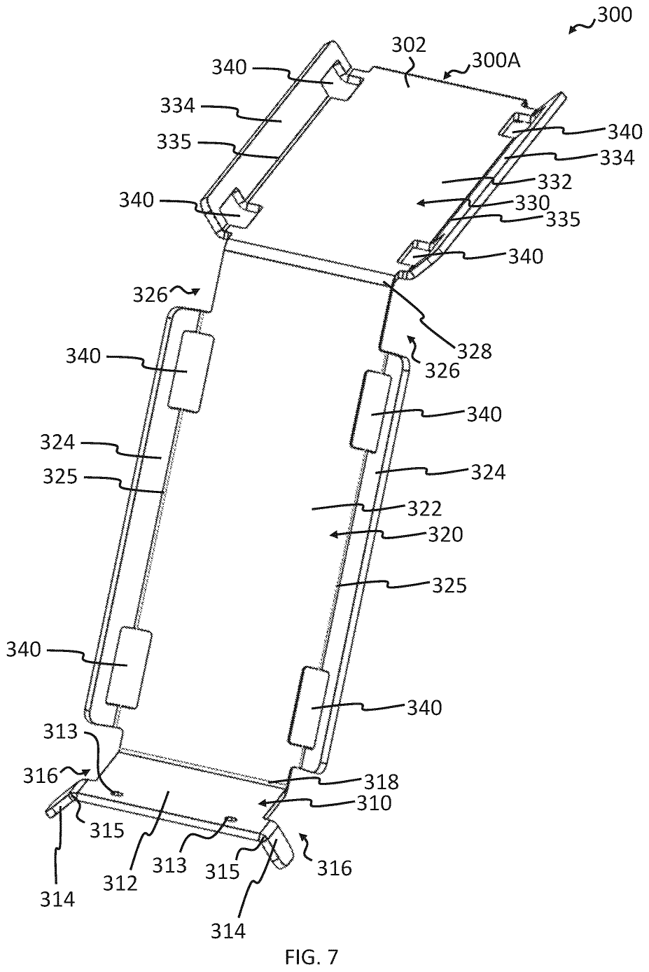

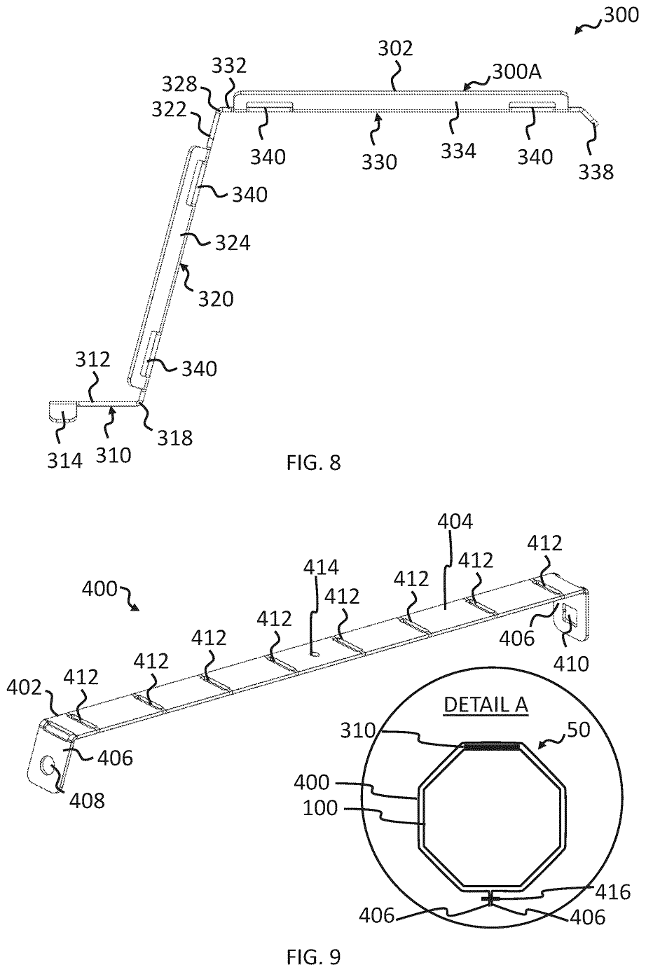

FIG. 5 illustrates a half-bridge cable diverter 300A. FIG. 6 illustrates a full-bridge cable diverter 300B. FIGS. 7-8 illustrates a cable diverter 300 implemented as a folded plate 302.

The cable diverter 300 and the torque tube 100 may be sold separately or provided as a system 40.

The cable diverter 300 comprises a base 310 securable to the exterior surface 101 of the torque tube 100, a leg 320 extending away from the base 310 to divert the cabling 102 away from the exterior surface 101 of the torque tube 100, and a beam 330 connected to the leg 320, extending along the torque tube 100.

The illustrated base 310 extends in a horizontal direction. The leg 320 extends in an upright, mostly vertical direction (>45 degrees), radially away from the axis X-X. The beam 330 is elevated above the exterior surface 101 of the torque tube 100 by the leg 320 and extends in a horizontal or mostly horizontal direction.

The base 310 of the cable diverter 300 is secured to the exterior surface 101 of the torque tube 100 by a fixing such as screws, and/or the strap described later in relation to FIG. 9. The base 310 is secured a short distance upstream of the bearing assembly 114. The cable diverter 300 may be secured to a face/side 103 of the torque tube 100 that generally faces the rear of the solar panel 106.

The illustrated leg 320 of the cable diverter 300 is upright but at an oblique angle relative to the horizontal base 310 and horizontal beam 330 of the cable diverter 300. The top of the leg 320 is therefore downstream from the bottom of the leg 320 along the X-X direction. The top of the leg 320 is therefore further from the base 310 than the bottom of the leg 320 in the X-X direction.

In some examples, the internal angle between the base 310 and the leg 320 is an obtuse angle of 105 degrees, as shown. The internal angle between the leg 320 and the beam 330 is an obtuse angle of 105 degrees. It would be appreciated that the specific value of the angle may depend on implementation. The base 310 is upstream of the leg 320 and the beam 330 is downstream of the leg 320, extending downstream. In another example, the base 310 and beam 330 are to the same side of the leg 320 such that a C-shape is defined.

In examples, the total height of the cable diverter 300 is a value selected from the range 10 cm to 20 cm. The specific height depends on any space constraints, such as limited space between the face/side 103 of the torque tube 100 and other objects such as the rear of the solar panel 106 (see FIGS. 3-4). The height is implementation-dependent. The height of the leg 320 may be selected from this range.

In the first, ‘half-bridge’ cable diverter 300A of FIG. 5, the beam 330 is a cantilever beam, cantilevered from the top of the leg 320.

In FIG. 5, the cabling 102 is secured to the torque tube 100, the leg 320, and the cantilever beam 330, by cable fasteners 118 such as plastic cable ties. The cabling 102 then drops from the free end of the beam 330 back to the exterior surface 101 of the torque tube 100, reaching the exterior surface 101 downstream of the bearing assembly 114. A further cable fastener 118 secures the cabling 102 to the torque tube 100, downstream of the bearing assembly 114.

The total elevated span of the cable diverter 300, from the bottom of the leg 320 to the free end of the beam 330, along the X-X axis, is a value selected from the range 15 cm to 30 cm. A specific example is 20 cm. This ensures that the required number of bearing assemblies 114 is cleared.

In examples, the beam 330 is longer than the base 310. The free end of the beam 330 is downstream of the fixed end of the beam 330 at the top of the leg 320. The length of the beam 330 from the top of the leg 320 to the free end of the beam 330 may be selected from the above range.

In the second, ‘full bridge’ cable diverter 300B of FIG. 6, the beam 330 is connected to a pair of the legs 320. Each end of the beam 330 is connected to a respective opposite leg 320. Each opposite leg 320 is connected to a respective opposite base 310.

The opposite legs 320 may have the same features as each other, and may even be identical. However, the opposite legs 320 may be angled towards each other as shown, with the obtuse angles being defined.

The opposite bases 310 may have the same features as each other, and may even be identical. The opposite legs 320 and bases 310 may be opposed, such as symmetrically opposed.

The total elevated span of the cable diverter 300 may be greater than that of FIG. 5, such as a value from the range 25 cm to 50 cm. This ensures that the required number of bearing assemblies 114 is cleared. The length of the beam 330 between the tops of the opposite legs 320 may be selected from this range.

FIGS. 7-8 illustrate perspective and side views, respectively, of an example implementation of a cable diverter 300. The illustrations may be regarded as a complete half-bridge cable diverter 300A, but alternatively could be regarded as half a view of a full-bridge cable diverter 300B.

FIGS. 7-8 illustrate several additional features, which can be taken alone to achieve any one or more of the advantages described in the summary, and which can be taken in any combination to achieve any one or more of the advantages described in the summary.

In the illustrated example, the cable diverter 300 consists of a plate 302, formed by a manufacturing process into a bent plate form having several plate sections of the plate 302, connected by bends 315, 318, 325, 328, 335, 338. The bends 315, 318, 325, 328, 335, 338 may be created by any appropriate forming process such as pressing. The plate 302 may be formed of a metal material, without limitation.

The bends 315, 318, 325, 328, 335, 338 of the cable diverter 300 may define obtuse internal angles, and the cable diverter 300 may be free from any undercuts that would prevent stacking and nesting. Therefore, a plurality of cable diverters 300 can be stacked and nested with minimal voids therebetween.

The base 310 is a first plate section of the plate 302, the leg 320 is a second plate section of the plate 302, and the beam 330 is a third plate section of the plate 302. The base 310 is connected to the leg 320 by at least one lower bend 318 (lower edge), defining the bottom of the leg 320. The beam 330 is connected to the leg 320 by at least one upper bend 328 (lower edge), defining the top of the leg 320. In FIGS. 7-8, a single lower bend 318 is shown and a single upper bend 328 is shown.

The base 310 is shaped to fit the torque tube 100. The base 310 comprises a pair of lateral protrusions 314 in the form of base flaps, and a central base floor 312 therebetween. The lateral protrusions 314 are to opposite sides of the base floor 312.

The base floor 312 matches the shape of the face/side 103 of the torque tube 100. For example, the base floor 312 may be flat. The base floor 312 may be approximately of the same width as the face/side 103 of the torque tube 100.

The lateral protrusions 314 are smaller than the base floor 312. The lateral protrusions 314 extend laterally (perpendicular to X-X) away from the base floor 312, and are bent down towards the torque tube 100. The lateral protrusions 314 therefore extend down below the level of the base floor 312. The lateral protrusions 314 help to seat the cable diverter 300, and to retain a strap such as that described in relation to FIG. 9.

The lateral protrusions 314 are connected to the base floor 312 by bends 315 extending in the X-X direction. Where the torque tube 100 is polygonal, the lateral protrusions 314 extend partway over a pair of adjacent faces of the torque tube 100, adjacent to the face 103 of the torque tube 100.

The base 310 optionally comprises one or more fixing points 313, such as fixing holes. This enables fixings such as screws to be used to attach the cable diverter 300 to the torque tube 100. As shown, a fixing point 313 can extend through the base floor 312. Additionally, or alternatively, a fixing point can extend through a lateral protrusion 314 of the base 310. The fixing point 313 can provide an earthing point if needed.

Moving on to the leg 320, FIGS. 7-8 illustrate the leg 320 being shaped as a cable tray. The leg 320 comprises a pair of lateral protrusions 314 bent up at bends 325 to define leg support rails 324, and a central leg floor 322 therebetween. The leg support rails 324 are to laterally retain the cabling 102 when the cabling 102 is laid along the leg floor 322.

The leg floor 322 may have approximately the same width as the base floor 312. The length of the leg floor 322 defines the height of the leg 320.

The illustrated leg support rails 324 are shorter than the leg floor 322. Lower discontinuities 316 (gaps) are provided between the leg support rails 324 and the lateral protrusions 314 of the base 310. The lower discontinuities 316 enable the leg support rails 324 to be bent in an opposite, upwards direction than the lateral protrusions 314 of the base 310. Further, the lower discontinuities 316 are aligned with the lower bend 318, to minimise the force required to form the lower bend 318.

Moving on to the beam 330, FIGS. 7-8 illustrate the beam 330 being shaped as a cable tray. The beam 330 comprises a pair of lateral protrusions bent up at X-X axis bends 335 to define beam support rails 334, and a central beam floor 332 therebetween. The beam support rails 334 are to laterally retain the cabling 102 when the cabling 102 is laid along the beam floor 332.

The beam floor 332 may have approximately the same width as the leg floor 322. The length of the beam floor 332 defines the length of the beam 330.

The illustrated beam support rails 334 are shorter than the beam floor 332. Upper discontinuities 326 (gaps) are provided between the leg support rails 324 and the beam support rails 334. The upper discontinuities 326 are aligned with the upper bend 328, to minimise the force required to form the upper bend 328. If a roll forming process can be used, the need for such discontinuities could be obviated.

The side view of FIG. 8 shows the beam 330 comprising a turned-down free end 338. This is specific to the half-bridge cable diverter 300A. For the full-bridge cable diverter 300B, this would be replaced by a connection to a separate leg 320.

FIGS. 7-8 further illustrate the leg 320 and beam 330 each comprising a plurality of pairs of fastening points 340, to receive cable fasteners 118 such as plastic cable ties for biasing the cabling 102 against the leg floor 322 and beam floor 332. The fastening points 340 are in the form of through-holes, extending partially into the respective support rail and partially into the respective floor. In other words, the bends 325, 335 extend through the fastening points 340. The number of pairs of fastening points 340 depends on implementation. In some implementations, the cabling 102 may be secured to only the leg 320 or only the beam 330. In some implementations, the cabling 102 may be loose.

Turning now to FIG. 9, a malleable strap 400 is illustrated for use with the cable diverter 300. The malleable strap 400 securely wraps around the torque tube 100 and the base 310 of the cable diverter 300, obviating the need to drill holes in the torque tube 100. The malleable strap 400 and the cable diverter 300 may be provided as a system 50. The system may further include the torque tube 100.

The malleable strap 400 comprises a plate 402 made of a malleable material such as a metal. The malleable strap 400 comprises a wrapping portion 404 having a length approximately as long as a circumference of the torque tube 100. The ends of the wrapping portion 404 are connected to attachment portions 406 that are fastenable together.

Where the torque tube 100 is polygonal, the wrapping portion 404 of the malleable strap 400 comprises a plurality of living hinges 412, each defined by a cutout in the form of a slot extending across the wrapping portion 404. The position of each living hinge 412 corresponds to the position of each vertex of the torque tube 100. The separation of each living hinge 412 corresponds to the length of each edge of the torque tube 100. The malleable strap 400 may be slightly oversized relative to the torque tube 100, to accommodate the base 310 of the cable diverter 300 against the torque tube 100. The dimensions of the malleable strap 400 therefore depend on those of the torque tube 100.

The attachment portions 406 of the malleable strap 400 may be bent relative to the wrapping portion 404, for example using similar living hinges. This enables the attachment portions 406 to face each other. Holes 408, 410 in the attachment portions 406 align to receive a fixing 416 therethrough.

The malleable strap 400 may arrive with the installer in either a straight configuration, a pre-bent configuration, or a partially pre-bent configuration.

An optional fixing point 414, such as a fixing hole, may be provided along the wrapping portion 404. This enables a fixing such as a screw to be used to attach the malleable strap 400 to the torque tube 100 and/or to the base 310 of the cable diverter 300.

In a specific implementation, the installer can position the malleable strap 400 to align with the portion of the base floor 312 located between the lateral protrusions 314 of the base 310 and the lower bend 318. The malleable strap 400 is aligned with the lower discontinuity 316. This alignment ensures that when the malleable strap 400 is wrapped, the cable diverter 300 cannot slip out of the malleable strap 400 without interference (with the lateral protrusions 314 or with the leg 320).

If the cable diverter 300 is a full-bridge cable diverter 300B, a pair of malleable straps 400 may be provided—one for each base 310 of the cable diverter 300B.

Although not shown, the malleable strap 400 can comprise multiple series' of the living hinges 412, each series defining a different folding pattern. Each folding pattern defines a different polygonal shape. This makes the malleable strap 400 compatible with a range of torque tube shapes, such as octagonal and hexagonal torque tubes.

A method of assembly can be defined. The method comprises:
placing the cable diverter 300 against the exterior surface 101 of the torque tube 100;
positioning a fixing, such as a strap (e.g., malleable strap 400), over the cable diverter 300;
securing the cable diverter 300 to the exterior surface 101 of the torque tube 100 via the fixing;
laying cabling 102 onto the cable diverter 300; and
optionally, securing the cabling 102 to the cable diverter 300 using cable fasteners 118 such as plastic cable ties.

Although embodiments of the present invention have been described in the preceding paragraphs with reference to various examples, it should be appreciated that modifications to the examples given can be made without departing from the scope of the invention as claimed. For example:
the cable diverter 300 could be secured to another article such as the rear of the solar panel 106, rather than to the torque tube 100. The cable diverter's beam 330 could be located in proximity to, and extending over the adjacent bearing assembly 114. However, the cable diverter 300 would then be static and would not move with the cabling 102.
the cabling 102 could be replaced by another equivalent flexible elongate article, such as one or more hoses. In such examples, the apparatus 300 could be referred to more broadly as a diverter, or as a conduit diverter;
the base 310 may be omitted and the leg 320 secured directly to the torque tube 100, for example via a weld;
the beam 330 may be omitted, or may be a portion of a continuously curved leg 320 such as the top of an ‘S’ shape, rather than a separate section connected to the leg 320 by a defined edge;
the malleable strap 400 may be an integrally formed portion of the cable diverter 300;
the malleable strap 400 may be replaced by other fixing means such as screws.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavoring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A system comprising a torque tube and a cable diverter securable to an exterior surface of the torque tube, the cable diverter comprising a base securable to the exterior surface of the torque tube, and a leg to divert an elongate article away from the exterior surface of the torque tube, and wherein the elongate article is cabling.

2. The system of claim 1, wherein the leg of the cable diverter comprises an oblique angle to the base of the cable diverter.

3. The system of claim 1, wherein a height of the leg is a value from the range approximately five centimetres to approximately 30 centimetres.

4. The system of claim 1, wherein the leg is a section of a same plate as the base, and/or wherein the leg is connected to the base via an edge comprising a bend.

5. The system of claim 1, wherein the leg is configured to secure the cabling, the leg comprising a leg fastening point to receive a cable fastener.

6. (canceled)

7. The system of claim 1, wherein the leg is configured to secure the cabling, the leg being shaped as a cable tray, wherein the leg comprises a leg floor and a pair of leg support rails, wherein the leg support rails are left and right support rails, the leg floor extending therebetween, wherein the leg floor and the leg support rails are arranged to define the cable tray, and wherein the leg support rails and leg floor extend along the leg.

8. The system of claim 7, wherein the leg support rails are at an oblique angle to the leg floor.

9. (canceled)

10. The system of claim 1, wherein the cable diverter comprises a beam elevated from the base by the leg.

11. The system of claim 10, wherein the beam is a section of a same plate as the leg, and/or wherein the beam is connected to the leg via an edge comprising a bend.

12. The system of claim 10, wherein the beam is configured to secure the cabling, the beam comprising a beam fastening point to receive a cable fastener.

13. (canceled)

14. The system of claim 10, wherein the beam is configured to secure the cabling, the beam being shaped as a cable tray, wherein the beam comprises a beam floor and a pair of beam support rails, wherein the beam support rails are left and right support rails, the beam floor extending therebetween, wherein the beam floor and the beam support rails are arranged to define the cable tray, and wherein the beam support rails and beam floor extend along the beam.

15. (canceled)

16. (canceled)

17. The system of claim 14, wherein the leg is configured to secure the cabling, the leg being shaped as a cable tray, wherein the leg comprises a leg floor and a pair of leg support rails, wherein the leg support rails are left and right support rails, the leg floor extending therebetween, wherein the leg floor and the leg support rails are arranged to define the cable tray, wherein the leg support rails and leg floor extend along the leg, wherein the leg support rails are separated from the beam support rails by discontinuities.

18. The system of claim 10, wherein the beam is a cantilever beam, cantilevered from the leg.

19. The system of claim 18, wherein the beam comprises a turned-down free end.

20. The system of claim 1, further comprising a strap to secure the cable diverter to the torque tube.

21. The system of claim 20, wherein the base of the cable diverter comprises lateral protrusions and a floor therebetween, the lateral protrusions and the leg together preventing the base from sliding out of the strap when the strap is in a fastened state.

22. The system of claim 20, wherein the torque tube is polygonal in cross-section, wherein the strap is a malleable strap, wherein the malleable strap comprises living hinges, and wherein a location of each living hinge corresponds to the location of a corresponding vertex of the torque tube.

23. (canceled)

24. The system of claim 1, wherein the torque tube is a solar tracker torque tube of a solar tracker system.

25. A cable diverter comprising a base securable to an exterior surface of an article, a leg extending away from the base, and a beam elevated from the base by the leg, and configured to secure cabling, wherein the exterior surface of the article is a face of a torque tube.

26. The system of claim 1, wherein the base is secured proximal to and upstream of a bearing assembly.
